(19) United States
(12) Patent Application Publication
(10) Pub. No.: US 2011/0087715 A1
(43) Pub. Date: Apr. 14, 2011

(54) METHOD AND APPARATUS FOR PREPARING MAP DATA

(76) Inventors: David Martens, Utrecht (NL); Bert Jasper Spaan, Utrecht (NL)

(21) Appl. No.: 12/736,770

(22) PCT Filed: Jun. 4, 2008
(86) PCT No.: PCT/EP2008/004558

§ 371 Date: Dec. 23, 2010

(51) Int. Cl. G06F 7/00

(52) U.S. Cl. 708/200

(57) ABSTRACT

A method is disclosed for using a suitably programmed computer to fit a circular arc to a plurality of points, which form map data representing a feature. In at least one embodiment, the method includes determining whether a region, in which a centre of a circle intersecting a first point and a region around at least one mid-point lies, intersects a perpendicular bisector of a line intersecting the first point and a second point. At least one embodiment of the method is suitable for preparing navigation maps and is applicable to any processing device configured to execute navigation software.

### FIELD OF THE INVENTION

This invention relates to navigation devices and to methods for preparing navigation maps for use with navigation devices. Illustrative embodiments of the invention relate to portable navigation devices (so-called PNDs), in particular PNDs that include Global Positioning System (GPS) signal reception and processing functionality and map data for use therewith. Other embodiments relate, more generally, to any type of processing device that is configured to execute navigation software so as to provide route planning, and preferably also navigation, functionality using map data.

### BACKGROUND TO THE INVENTION

Portable navigation devices (PNDs) that include GPS (Global Positioning System) signal reception and processing functionality are well known and are widely employed as in-car or other vehicle navigation systems.

In general terms, a modern PND comprises a processor, memory (at least one of volatile and non-volatile, and commonly both), and map data stored within said memory. The processor and memory cooperate to provide an execution environment in which a software operating system may be established, and additionally it is commonplace for one or more additional software programs to be provided to enable the functionality of the PND to be controlled, and to provide various other functions.

Typically these devices further comprise one or more input interfaces that allow a user to interact with and control the device, and one or more output interfaces by means of which information may be relayed to the user. Illustrative examples of output interfaces include a visual display and a speaker for audible output. Illustrative examples of input interfaces include one or more physical buttons to control on/off operation or other features of the device (which buttons need not necessarily be on the device itself but could be on a steering wheel if the device is built into a vehicle), and a microphone for detecting user speech. In a particularly preferred arrangement the output interface display may be configured as a touch sensitive display (by means of a touch sensitive overlay or otherwise) to additionally provide an input interface by means of which a user can operate the device by touch.

Devices of this type will also often include one or more physical connector interfaces by means of which power and optionally data signals can be transmitted to and received from the device, and optionally one or more wireless transmitters/receivers to allow communication over cellular telecommunications and other signal and data networks, for example Wi-Fi, Wi-Max GSM and the like.

PND devices of this type also include a GPS antenna by means of which satellite-broadcast signals, including location data, can be received and subsequently processed to determine a current location of the device.

The PND device may also include electronic gyroscopes and accelerometers which produce signals that can be processed to determine the current angular and linear acceleration, and in turn, and in conjunction with location information derived from the GPS signal, velocity and relative displacement of the device and thus the vehicle in which it is mounted. Typically such features are most commonly provided in in-vehicle navigation systems, but may also be provided in PND devices if it is expedient to do so.

The utility of such PNDs is manifested primarily in their ability to determine a route between a first location (typically a start or current location) and a second location (typically a destination). These locations can be input by a user of the device, by any of a wide variety of different methods, for example by postcode, street name and house number, previously stored “well known” destinations (such as famous locations, municipal locations (such as sports grounds or swimming baths) or other points of interest), and favourite or recently visited destinations.

Typically, the PND is enabled by software for computing a “best” or “optimum” route between the start and destination address locations from the map data. A “best” or “optimum” route is determined on the basis of predetermined criteria and need not necessarily be the fastest or shortest route. The selection of the route along which to guide the driver can be very sophisticated, and the selected route may take into account existing, predicted and dynamically and/or wirelessly received traffic and road information, historical information about road speeds, and the driver's own preferences for the factors determining road choice (for example the driver may specify that the route should not include motorways or toll roads).

In addition, the device may continually monitor road and traffic conditions, and offer to or choose to change the route over which the remainder of the journey is to be made due to changed conditions. Real time traffic monitoring systems, based on various technologies (e.g. mobile phone data exchanges, fixed cameras, GPS fleet tracking) are being used to identify traffic delays and to feed the information into notification systems.

PNDs of this type may typically be mounted on the dashboard or windscreen of a vehicle, but may also be formed as part of an on-board computer of the vehicle radio or indeed as part of the control system of the vehicle itself. The navigation device may also be part of a hand-held system, such as a PDA (Portable Digital Assistant) a media player, a mobile phone or the like, and in these cases, the normal functionality of the hand-held system is extended by means of the installation of software on the device to perform both route calculation and navigation along a calculated route.

Route planning and navigation functionality may also be provided by a desktop or mobile computing resource running appropriate software. For example, the Royal Automobile Club (RAC) provides an on-line route planning and navigation facility at http://www.rac.co.uk, which facility allows a user to enter a start point and a destination whereupon the server to which the user's PC is connected calculates a route (aspects of which may be user specified), generates a map, and generates a set of exhaustive navigation instructions for guiding the user from the selected start point to the selected destination. The facility also provides for pseudo three-dimensional rendering of a calculated route, and route preview functionality which simulates a user travelling along the route and thereby provides the user with a preview of the calculated route.

In the context of a PND, once a route has been calculated, the user interacts with the navigation device to select the desired calculated route, optionally from a list of proposed routes. Optionally, the user may intervene in, or guide the route selection process, for example by specifying that certain routes, roads, locations or criteria are to be avoided or are mandatory for a particular journey. The route calculation aspect of the PND forms one primary function, and navigation along such a route is another primary function.

During navigation along a calculated route, it is usual for such PNDs to provide visual and/or audible instructions to guide the user along a chosen route to the end of that route, i.e. the desired destination. It is also usual for PNDs to display map information on-screen during the navigation, such information regularly being updated on-screen so that the map information displayed is representative of the current location of the device, and thus of the user or user's vehicle if the device is being used for in-vehicle navigation.

An icon displayed on-screen typically denotes the current device location, and is centred with the map information of current and surrounding roads in the vicinity of the current device location and other map features also being displayed. Additionally, navigation information may be displayed, optionally in a status bar above, below or to one side of the displayed map information, examples of navigation information include a distance to the next deviation from the current road required to be taken by the user, the nature of that deviation possibly being represented by a further icon suggestive of the particular type of deviation, for example a left or right turn. The navigation function also determines the content, duration and timing of audible instructions by means of which the user can be guided along the route. As can be appreciated a simple instruction such as “turn left in 100 m” requires significant processing and analysis. As previously mentioned, user interaction with the device may be by a touch screen, or additionally or alternately by steering column mounted remote control, by voice activation or by any other suitable method.

A further important function provided by the device is automatic route re-calculation in the event that: a user deviates from the previously calculated route during navigation (either by accident or intentionally); real-time traffic conditions dictate that an alternative route would be more expedient and the device is suitably enabled to recognize such conditions automatically, or if a user actively causes the device to perform route re-calculation for any reason.

It is also known to allow a route to be calculated with user defined criteria; for example, the user may prefer a scenic route to be calculated by the device, or may wish to avoid any roads on which traffic congestion is likely, expected or currently prevailing. The device software would then calculate various routes and weigh more favourably those that include along their route the highest number of points of interest (known as POIs) tagged as being for example of scenic beauty, or, using stored information indicative of prevailing traffic conditions on particular roads, order the calculated routes in terms of a level of likely congestion or delay on account thereof. Other POI-based and traffic information-based route calculation and navigation criteria are also possible.

Although the route calculation and navigation functions are fundamental to the overall utility of PNDs, it is possible to use the device purely for information display, or “free-driving”, in which only map information relevant to the current device location is displayed, and in which no route has been calculated and no navigation is currently being performed by the device. Such a mode of operation is often applicable when the user already knows the route along which it is desired to travel and does not require navigation assistance.

Devices of the type described above, for example the 720T model manufactured and supplied by TomTom International B.V., provide a reliable means for enabling users to navigate from one position to another.

Map data for use with navigation devices typically includes many hundreds of thousands or even millions of points which indicate road shapes. For example, a single road is represented by a plurality of intermediate points indicating a path of the road. However, a memory necessary to store map data is often large in size and expensive, thereby increasing a cost of a navigation device or a data storage device or medium comprising new map data.

It is an aim of the present invention to address this problem, in particular to reduce the size of map data whilst still retaining a faithful representation of actual physical entities, such as roads.

### SUMMARY OF THE INVENTION

In pursuit of this aim, a presently preferred embodiment of the present invention provides a method of using a suitably programmed computer to fit a circular arc to a plurality of points, comprising determining whether a region, in which a centre of a circle intersecting a first point and a region around at least one mid-point lies, intersects a perpendicular bisector of a line intersecting the first point and a second point

Another embodiment of the present invention relates to computer software comprising one or more software modules operable, when executed in an execution environment, to cause a processor to determine whether a region, in which a centre of a circle intersecting a first point and a region around at least one mid-point lies, intersects a perpendicular bisector of a line intersecting the first point and a second point.

Yet another embodiment of the present invention relates to an apparatus comprising a processor; and a memory operatively coupled to the processor; characterised in that the memory comprises a plurality of points; and the processor is arranged to determine whether a region, in which a centre of a circle intersecting a first point and a region around at least one mid-point lies, intersects a perpendicular bisector of a line intersecting the first point and a second point.

Advantages of these embodiments are set out hereafter, and further details and features of each of these embodiments are defined in the accompanying dependent claims and elsewhere in the following detailed description.

### BRIEF DESCRIPTION OF THE DRAWINGS

Various aspects of the teachings of the present invention, and arrangements embodying those teachings, will hereafter be described by way of illustrative example with reference to the accompanying drawings, in which:

FIG. 1 is a schematic illustration of a Global Positioning System (GPS);

FIG. 2 is a schematic illustration of electronic components arranged to provide a navigation device;

FIG. 3 is a schematic illustration of the manner in which a navigation device may receive information over a wireless communication channel;

FIGS. 4A and 4B are illustrative perspective views of a navigation device;

FIG. 5 is a representation of three point forming a polyline and a circular arc intersecting first and last points, and an error disc surrounding an intermediate point;

FIG. 6 is a representation of a point, an error disc surrounding another point and loci formed by a set of circles tangential to an inside of the error disc and a set of circles tangential to an outside of the error disc;

FIG. 7 is representation of an intersection of a plurality of hyperbola formed between a plurality of points;

FIG. 8 is a method forming an embodiment of the present invention;

FIG. 9 is a method of calculating a value of a distance between a line intersecting first and second points and an arc; and

FIG. 10 is a representation of an approximation to a hyperbola;

FIG. 11 is a representation of a plurality of points forming a polyline fitted with an approximation showing a maximum linear deviation;

FIG. 12 is a representation of a plurality of points forming a polyline fitted with an approximation showing a maximum angular deviation; and

FIG. 13 is a comparison of polylines formed by a plurality of points and circular arcs approximating the polylines.

### DETAILED DESCRIPTION OF PREFERRED EMBODIMENTS

Preferred embodiments of the present invention will now be described with particular reference to a PND. It should be remembered, however, that the teachings of the present invention are not limited to PNDs but are instead universally applicable to any type of processing device that is configured to execute navigation software so as to provide route planning and navigation functionality. It follows therefore that in the context of the present application, a navigation device is intended to include (without limitation) any type of route planning and navigation device, irrespective of whether that device is embodied as a PND, a navigation device built into a vehicle, or indeed a computing resource (such as a desktop or portable personal computer (PC), mobile telephone or portable digital assistant (PDA)) executing route planning and navigation software.

It will also be apparent from the following that the teachings of the present invention even have utility in circumstances where a user is not seeking instructions on how to navigate from one point to another, but merely wishes to be provided with a view of a given location. In such circumstances the “destination” location selected by the user need not have a corresponding start location from which the user wishes to start navigating, and as a consequence references herein to the “destination” location or indeed to a “destination” view should not be interpreted to mean that the generation of a route is essential, that travelling to the “destination” must occur, or indeed that the presence of a destination requires the designation of a corresponding start location.

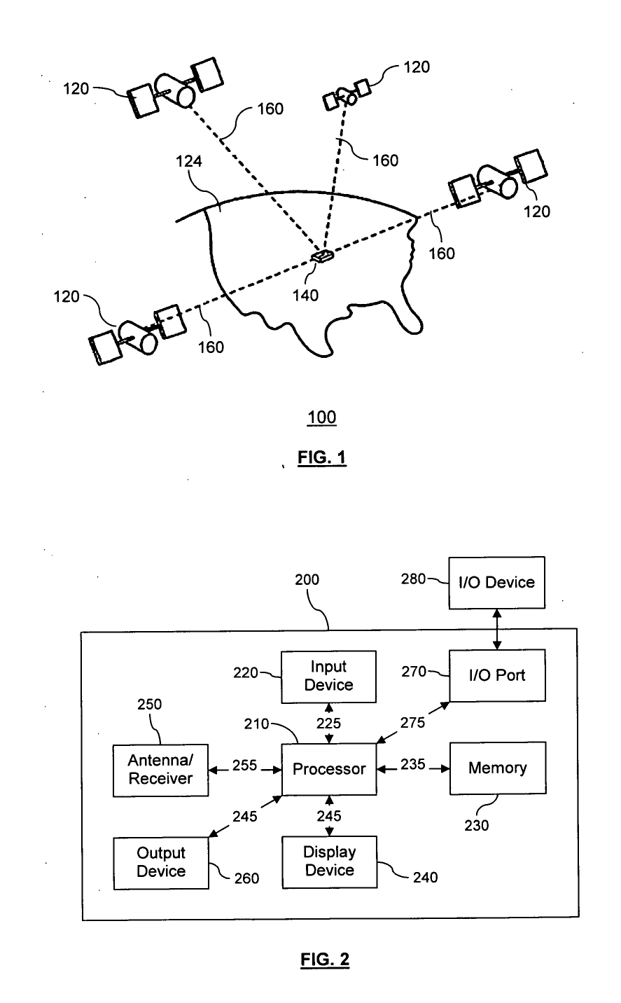

With the above provisos in mind, FIG. 1 illustrates an example view of Global Positioning System (GPS), usable by navigation devices. Such systems are known and are used for a variety of purposes. In general, GPS is a satellite-radio based navigation system capable of determining continuous position, velocity, time, and in some instances direction information for an unlimited number of users. Formerly known as NAVSTAR, the GPS incorporates a plurality of satellites which orbit the earth in extremely precise orbits. Based on these precise orbits, GPS satellites can relay their location to any number of receiving units.

The GPS system is implemented when a device, specially equipped to receive GPS data, begins scanning radio frequencies for GPS satellite signals. Upon receiving a radio signal from a GPS satellite, the device determines the precise location of that satellite via one of a plurality of different conventional methods. The device will continue scanning, in most instances, for signals until it has acquired at least three different satellite signals (noting that position is not normally, but can be determined, with only two signals using other triangulation techniques). Implementing geometric triangulation, the receiver utilizes the three known positions to determine its own two-dimensional position relative to the satellites. This can be done in a known manner. Additionally, acquiring a fourth satellite signal will allow the receiving device to calculate its three dimensional position by the same geometrical calculation in a known manner. The position and velocity data can be updated in real time on a continuous basis by an unlimited number of users.

As shown in FIG. 1, the GPS system is denoted generally by reference numeral 100. A plurality of satellites 120 are in orbit about the earth 124. The orbit of each satellite 120 is not necessarily synchronous with the orbits of other satellites 120 and, in fact, is likely asynchronous. A GPS receiver 140 is shown receiving spread spectrum GPS satellite signals 160 from the various satellites 120.

The spread spectrum signals 160, continuously transmitted from each satellite 120, utilize a highly accurate frequency standard accomplished with an extremely accurate atomic clock. Each satellite 120, as part of its data signal transmission 160, transmits a data stream indicative of that particular satellite 120. It is appreciated by those skilled in the relevant art that the GPS receiver device 140 generally acquires spread spectrum GPS satellite signals 160 from at least three satellites 120 for the GPS receiver device 140 to calculate its two-dimensional position by triangulation. Acquisition of an additional signal, resulting in signals 160 from a total of four satellites 120, permits the GPS receiver device 140 to calculate its three-dimensional position in a known manner.

FIG. 2 is an illustrative representation of electronic components of a navigation device 200 according to a preferred embodiment of the present invention, in block component format. It should be noted that the block diagram of the navigation device 200 is not inclusive of all components of the navigation device, but is only representative of many example components.

The navigation device 200 is located within a housing (not shown). The housing includes a processor 210 connected to an input device 220 and a display screen 240. The input device 220 can include a keyboard device, voice input device, touch panel and/or any other known input device utilised to input information; and the display screen 240 can include any type of display screen such as an LCD display, for example. In a particularly preferred arrangement the input device 220 and display screen 240 are integrated into an integrated input and display device, including a touchpad or touchscreen input so that a user need only touch a portion of the display screen 240 to select one of a plurality of display choices or to activate one of a plurality of virtual buttons.

The navigation device may include an output device 260, for example an audible output device (e.g. a loudspeaker). As output device 260 can produce audible information for a user of the navigation device 200, it is should equally be understood that input device 240 can include a microphone and software for receiving input voice commands as well.

In the navigation device 200, processor 210 is operatively connected to and set to receive input information from input device 220 via a connection 225, and operatively connected to at least one of display screen 240 and output device 260, via output connections 245, to output information thereto. Further, the processor 210 is operatively connected to memory 230 via connection 235 and is further adapted to receive/send information from/to input/output (I/O) ports 270 via connection 275, wherein the I/O port 270 is connectable to an I/O device 280 external to the navigation device 200. The external I/O device 280 may include, but is not limited to an external listening device such as an earpiece for example. The connection to I/O device 280 can further be a wired or wireless connection to any other external device such as a car stereo unit for hands-free operation and/or for voice activated operation for example, for connection to an ear piece or head phones, and/or for connection to a mobile phone for example, wherein the mobile phone connection may be used to establish a data connection between the navigation device 200 and the internet or any other network for example, and/or to establish a connection to a server via the Internet or some other network for example.

FIG. 2 further illustrates an operative connection between the processor 210 and an antenna/receiver 250 via connection 255, wherein the antenna/receiver 250 can be a GPS antenna/receiver for example. It will be understood that the antenna and receiver designated by reference numeral 250 are combined schematically for illustration, but that the antenna and receiver may be separately located components, and that the antenna may be a GPS patch antenna or helical antenna for example.

Further, it will be understood by one of ordinary skill in the art that the electronic components shown in FIG. 2 are powered by power sources (not shown) in a conventional manner. As will be understood by one of ordinary skill in the art, different configurations of the components shown in FIG. 2 are considered to be within the scope of the present application. For example, the components shown in FIG. 2 may be in communication with one another via wired and/or wireless connections and the like. Thus, the scope of the navigation device 200 of the present application includes a portable or handheld navigation device 200.

In addition, the portable or handheld navigation device 200 of FIG. 2 can be connected or “docked” in a known manner to a vehicle such as a bicycle, a motorbike, a car or a boat for example. Such a navigation device 200 is then removable from the docked location for portable or handheld navigation use.

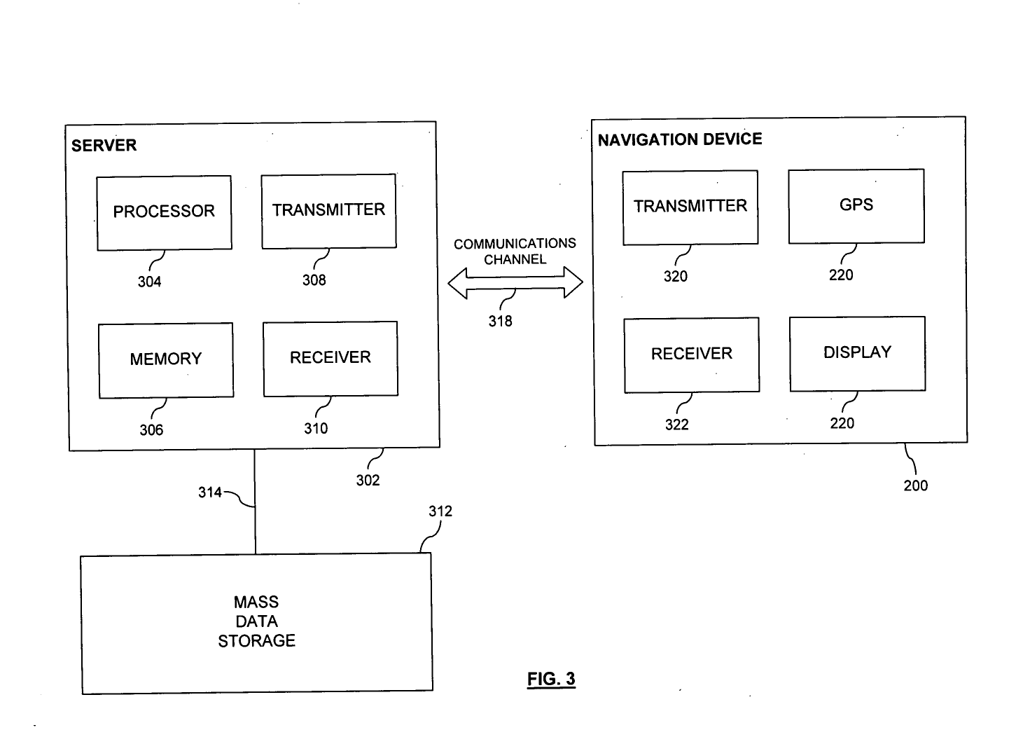

Referring now to FIG. 3, the navigation device 200 may establish a “mobile” or telecommunications network connection with a server 302 via a mobile device (not shown) (such as a mobile phone, PDA, and/or any device with mobile phone technology) establishing a digital connection (such as a digital connection via known Bluetooth technology for example). Thereafter, through its network service provider, the mobile device can establish a network connection (through the Internet for example) with a server 302. As such, a “mobile” network connection is established between the navigation device 200 (which can be, and often times is mobile as it travels alone and/or in a vehicle) and the server 302 to provide a “real-time” or at least very “up to date” gateway for information.

The establishing of the network connection between the mobile device (via a service provider) and another device such as the server 302, using an internet (such as the World Wide Web) for example, can be done in a known manner. This can include use of TCP/IP layered protocol for example. The mobile device can utilize any number of communication standards such as CDMA, GSM, WAN, etc.

As such, an internet connection may be utilised which is achieved via data connection, via a mobile phone or mobile phone technology within the navigation device 200 for example. For this connection, an internet connection between the server 302 and the navigation device 200 is established. This can be done, for example, through a mobile phone or other mobile device and a GPRS (General Packet Radio Service)-connection (GPRS connection is a high-speed data connection for mobile devices provided by telecom operators; GPRS is a method to connect to the Internet).

The navigation device 200 can further complete a data connection with the mobile device, and eventually with the internet and server 302, via existing Bluetooth technology for example, in a known manner, wherein the data protocol can utilize any number of standards, such as the GSRM, the Data Protocol Standard for the GSM standard, for example.

The navigation device 200 may include its own mobile phone technology within the navigation device 200 itself (including an antenna for example, or optionally using the internal antenna of the navigation device 200). The mobile phone technology within the navigation device 200 can include internal components as specified above, and/or can include an insertable card (e.g. Subscriber Identity Module or SIM card), complete with necessary mobile phone technology and/or an antenna for example. As such, mobile phone technology within the navigation device 200 can similarly establish a network connection between the navigation device 200 and the server 302, via the internet for example, in a manner similar to that of any mobile device.

For GRPS phone settings, a Bluetooth enabled navigation device may be used to correctly work with the ever changing spectrum of mobile phone models, manufacturers, etc., model/manufacturer specific settings may be stored on the navigation device 200 for example. The data stored for this information can be updated.

In FIG. 3 the navigation device 200 is depicted as being in communication with the server 302 via a generic communications channel 318 that can be implemented by any of a number of different arrangements. The server 302 and a navigation device 200 can communicate when a connection via communications channel 318 is established between the server 302 and the navigation device 200 (noting that such a connection can be a data connection via mobile device, a direct connection via personal computer via the internet, etc.).

The server 302 includes, in addition to other components which may not be illustrated, a processor 304 operatively connected to a memory 306 and further operatively connected, via a wired or wireless connection 314, to a mass data storage device 312. The processor 304 is further operatively connected to transmitter 308 and receiver 310, to transmit and send information to and from navigation device 200 via communications channel 318. The signals sent and received may include data, communication, and/or other propagated signals. The transmitter 308 and receiver 310 may be selected or designed according to the communications requirement and communication technology used in the communication design for the navigation system 200. Further, it should be noted that the functions of transmitter 308 and receiver 310 may be combined into a signal transceiver.

Server 302 is further connected to (or includes) a mass storage device 312, noting that the mass storage device 312 may be coupled to the server 302 via communication link 314. The mass storage device 312 contains a store of navigation data and map information, and can again be a separate device from the server 302 or can be incorporated into the server 302.

The navigation device 200 is adapted to communicate with the server 302 through communications channel 318, and includes processor, memory, etc. as previously described with regard to FIG. 2, as well as transmitter 320 and receiver 322 to send and receive signals and/or data through the communications channel 318, noting that these devices can further be used to communicate with devices other than server 302. Further, the transmitter 320 and receiver 322 are selected or designed according to communication requirements and communication technology used in the communication design for the navigation device 200 and the functions of the transmitter 320 and receiver 322 may be combined into a single transceiver.

Software stored in server memory 306 provides instructions for the processor 304 and allows the server 302 to provide services to the navigation device 200. One service provided by the server 302 involves processing requests from the navigation device 200 and transmitting navigation data from the mass data storage 312 to the navigation device 200. Another service provided by the server 302 includes processing the navigation data using various algorithms for a desired application and sending the results of these calculations to the navigation device 200.

The communication channel 318 generically represents the propagating medium or path that connects the navigation device 200 and the server 302. Both the server 302 and navigation device 200 include a transmitter for transmitting data through the communication channel and a receiver for receiving data that has been transmitted through the communication channel.

The communication channel 318 is not limited to a particular communication technology. Additionally, the communication channel 318 is not limited to a single communication technology; that is, the channel 318 may include several communication links that use a variety of technology. For example, the communication channel 318 can be adapted to provide a path for electrical, optical, and/or electromagnetic communications, etc. As such, the communication channel 318 includes, but is not limited to, one or a combination of the following: electric circuits, electrical conductors such as wires and coaxial cables, fibre optic cables, converters, radio-frequency (RF) waves, the atmosphere, empty space, etc. Furthermore, the communication channel 318 can include intermediate devices such as routers, repeaters, buffers, transmitters, and receivers, for example.

In one illustrative arrangement, the communication channel 318 includes telephone and computer networks. Furthermore, the communication channel 318 may be capable of accommodating wireless communication such as radio frequency, microwave frequency, infrared communication, etc. Additionally, the communication channel 318 can accommodate satellite communication.

The communication signals transmitted through the communication channel 318 include, but are not limited to, signals as may be required or desired for given communication technology. For example, the signals may be adapted to be used in cellular communication technology such as Time Division Multiple Access (TDMA), Frequency Division Multiple Access (FDMA), Code Division Multiple Access (CDMA), Global System for Mobile Communications (GSM), etc. Both digital and analogue signals can be transmitted through the communication channel 318. These signals may be modulated, encrypted and/or compressed signals as may be desirable for the communication technology.

The server 302 includes a remote server accessible by the navigation device 200 via a wireless channel. The server 302 may include a network server located on a local area network (LAN), wide area network (WAN), virtual private network (VPN), etc.

The server 302 may include a personal computer such as a desktop or laptop computer, and the communication channel 318 may be a cable connected between the personal computer and the navigation device 200. Alternatively, a personal computer may be connected between the navigation device 200 and the server 302 to establish an internet connection between the server 302 and the navigation device 200. Alternatively, a mobile telephone or other handheld device may establish a wireless connection to the internet, for connecting the navigation device 200 to the server 302 via the internet.

The navigation device 200 may be provided with information from the server 302 via information downloads which may be periodically updated automatically or upon a user connecting navigation device 200 to the server 302 and/or may be more dynamic upon a more constant or frequent connection being made between the server 302 and navigation device 200 via a wireless mobile connection device and TCP/IP connection for example. For many dynamic calculations, the processor 304 in the server 302 may be used to handle the bulk of the processing needs, however, processor 210 of navigation device 200 can also handle much processing and calculation, oftentimes independent of a connection to a server 302.

As indicated above in FIG. 2, a navigation device 200 includes a processor 210, an input device 220, and a display screen 240. The input device 220 and display screen 240 are integrated into an integrated input and display device to enable both input of information (via direct input, menu selection, etc.) and display of information through a touch panel screen, for example. Such a screen may be a touch input LCD screen, for example, as is well known to those of ordinary skill in the art. Further, the navigation device 200 can also include any additional input device 220 and/or any additional output device 241, such as audio input/output devices for example.

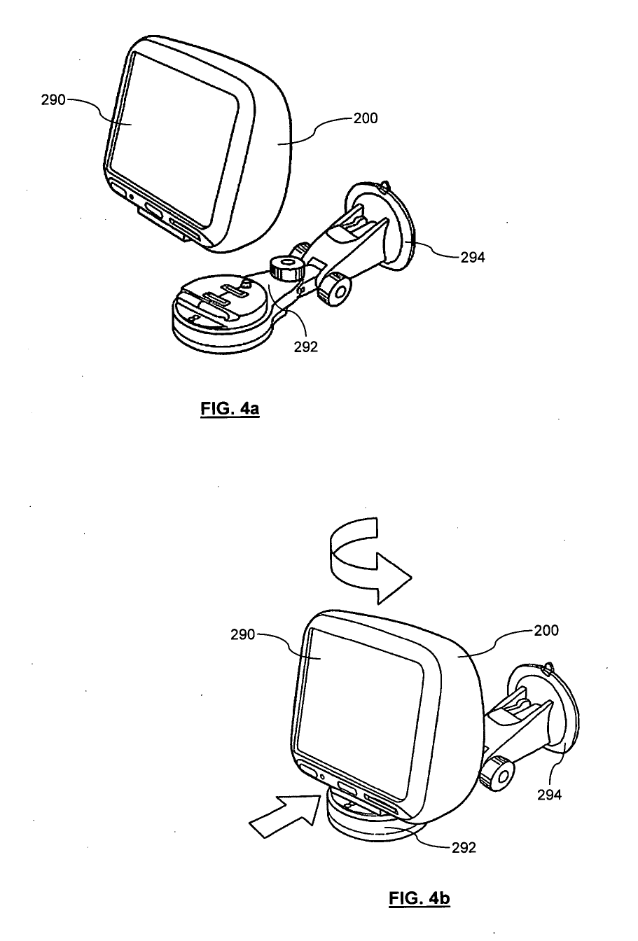

FIGS. 4A and 4B are perspective views of a navigation device 200. As shown in FIG. 4A, the navigation device 200 may be a unit that includes an integrated input and display device 290 (a touch panel screen for example) and the other components of FIG. 2 (including but not limited to internal GPS receiver 250, microprocessor 210, a power supply, memory systems 230, etc.).

The navigation device 200 may sit on an arm 292, which itself may be secured to a vehicle dashboard/window/etc. using a suction cup 294. This arm 292 is one example of a docking station to which the navigation device 200 can be docked.

As shown in FIG. 4B, the navigation device 200 can be docked or otherwise connected to an arm 292 of the docking station by snap connecting the navigation device 292 to the arm 292 for example. The navigation device 200 may then be rotatable on the arm 292, as shown by the arrow of FIG. 4B. To release the connection between the navigation device 200 and the docking station, a button on the navigation device 200 may be pressed, for example. Other equally suitable arrangements for coupling and decoupling the navigation device to a docking station are well known to persons of ordinary skill in the art.

As discussed above, map data comprises pluralities of points which form polygonal lines or polylines to represent actual features such as roads. However, it is desired to simplify map data and to thus reduce a storage requirement for the map data by compressing the map data. Additionally, it is desired to make map data more visually appealing by improving representations of actual features such as roads.

Embodiments of the present invention seek to simplify map data by use of circular arcs. In particular, embodiments of the present invention simplify map data by replacing pluralities of points with a circular arc which approximates a path intersecting those points.

It is possible to fit a circular arc to a set of points using least squares fitting, which tries to minimise a total sum of squared distances R from each point forming a polyline and an arc, using the following equation:

$$R = {\sum }_{i = 0}^{n} Distance ( {p}_{i} , \hat{{p}_{0} {p}_{n}} )$$

Where [symbol] denotes a circular arc between points p₀ and pₙ.

However, a major disadvantage of least squares fitting is that to find all shortcuts possible for a polyline is computationally inefficient. For example, for a set of points pᵢ, . . . pⱼ establishing whether an arc is possible between pᵢ and pₖ does not establish whether an arc is possible between pᵢ and pₖ₊₁ and, therefore, a least squares fitting algorithm requires to computationally evaluate each possible subsection of a polyline, which is computationally expensive and slow. However, embodiments of the present invention are able to determine in advance whether an arc intersecting a start point, an end point, and error discs surrounding all intervening points is possible, thereby avoiding wasting computational resources.

An embodiment of the present invention will now be described. Embodiments of the present invention aim to replace, where possible, polylines with circular arcs which begin at a first point, end at a second point and pass through error disks of one or more points interposing the first and second points, as will be explained.

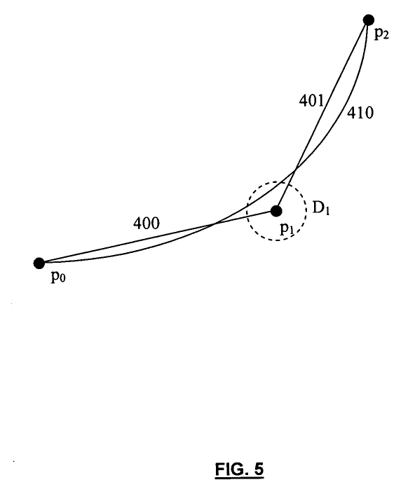

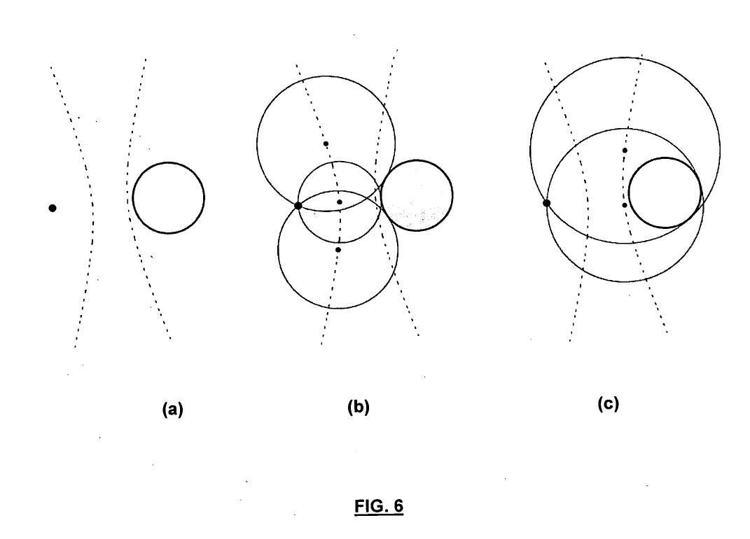

Referring to FIG. 5, three points p₀, p₁ and p₂ are shown which, in original map data, are linked by straight line segments 400, 401. In revised map data produced by embodiments of the present invention, points p₀ and p₂ are linked by a curved arc 410 which intersects an error disk D₁ of point p₁. An error disk is a disk of radius ε, which represents a predetermined maximum error distance around a point. All valid shortcuts bypassing a point must pass through its error disk.

It will now be explained how the centre of an arc intersecting a first point, an error disc of a second point and a third point as in FIG. 5 may be established.

According to the works of Apollonius of Perga, a third century B.C. philosopher, there are two possible circles which intersect two points and a circle. Therefore, a two-branched locus exists, one branch for a set of circles tangential to the inside of the circle, and one branch for a set of circles tangential to the outside. This is shown in FIG. 6. FIG. 6(a) shows a two-branched locus, FIG. 6(b) shows circles tangential to the inside of the circle, whilst FIG. 6(c) shows circles tangential to the outside of the circle.

Every circle with its centre inside the area described by the two branches of the locus can intersect with the point and the circle. The two branched locus can be represented as a hyperbola and an area between two branches of hyperbola intersecting p₀ and D₁ will be referred to herein as H_{D}_{₁}^{p}^{₀}.

If we now consider the situation of three points p₀, p₁ and p₂, it has been noted by the present inventors that every circle through p₀ and D₁ will have its centre in H_{D}_{₁}^{p}^{₀} whilst every circle through p₀ and D₂ will have its centre in H_{D}_{₂}^{p}^{₀}. Therefore, every circle through p₀, D₁ and D₂ will have its centre in both H_{D}_{₁}^{p}^{₀} and H_{D}_{₂}^{p}^{₀}. This can be written as H_{D}_{₁}^{p}^{₀}∩H_{D}_{₂}^{p}^{₀}. Therefore, given a polyline consisting of a plurality of points pᵢ, . . . , pⱼ the centre of a circle through pᵢ and the error disks Dᵢ₊₁, . . . , Dⱼ, of all the other points has to be inside the area A:

$$A = {{⋂}_{k = i + 1}}^{j - 1} {H}_{{D}_{k}}^{{p}_{i}}$$

Whether a circle is still possible through an existing set of points pᵢ, . . . , pⱼ and another point pⱼ₊₁ it is only necessary to compute the intersection of A and H_{D}_{ⱼ₊₁}^{p}^{ᵢ} thus saving unnecessary computing time evaluating all possibilities. A circle is possible when:

$$A ⋂ {H}_{{D}_{j + 1}}^{{p}_{i}} = {{⋂}_{k = i + 1}}^{j - i + 1} {H}_{{D}_{k}}^{{p}_{i}} \neq 0$$

However, it will be realised that an arc [symbol] is only possible if it ends exactly in the last point pⱼ₊₁, rather than through the point's error disk Dⱼ₊₁. In order to establish this, an intersection of A and a perpendicular bisector ⊥pᵢpⱼ₊ᵢ of pᵢ and pⱼ₊₁ is considered. A centre of the arc intersecting pᵢ and pⱼ₊₁ and the error disks of all intermediate points must lie on a line segment defined by the intersection of ⊥pᵢpⱼ₊ᵢ and A.

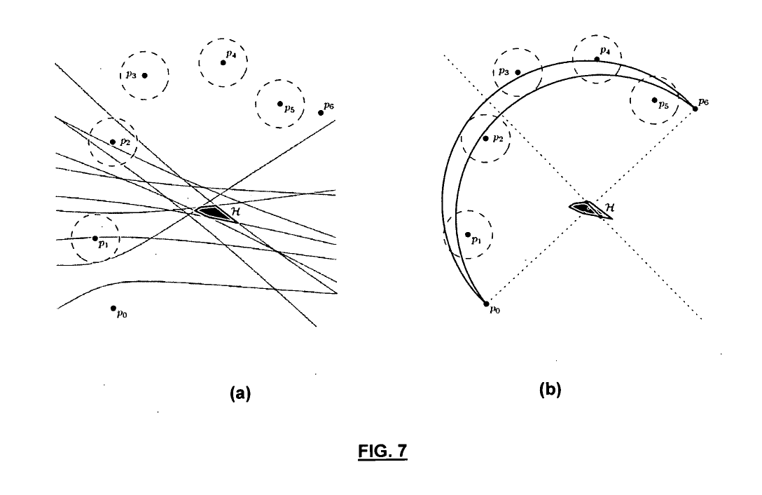

FIG. 7(a) shows an intersection of hyperbolas H_{D}_{₁}^{p}^{₀}, . . . , H_{D}_{_{S}}^{p}^{₀}. FIG. 7(b) shows the smallest and largest arcs possible from p₀ to p₆ intersecting error discs of points p₁-p₅ with their centres on A∩⊥p₀p₆.

Given two points, such as p₀ and p₆, a number d represents a distance between the vector \vec{p₀p₆}and error discs of points p₁-p₅. However, there are two values of d, one positive and one negative, which intersect the points and error discs and it is necessary to differentiate between them in order to find the shortest route.

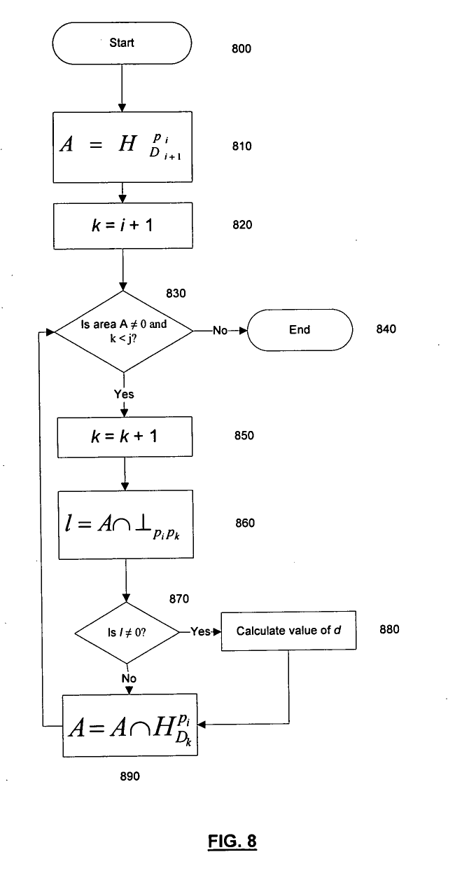

FIG. 8 shows method according to an embodiment of the present invention. The method determines if it is possible to approximate a plurality of points pᵢ, . . . , pⱼ with a circular arc and, if so, computes a value d for the arc.

The method begins in step 800. In step 810, an area value A is set to an area between two branches of a hyperbola between the first point pᵢ and an error disc of the second point Dᵢ₊₁. A value k is then set in step 820 to a value of an index to the second point i+1. In 830, it is determined if the area A has a value which is not equal to 0 and that k is less than j i.e. whether the final point of the plurality of points has been reached. If both conditions are met, then the method continues in step 850. If, however, one or both conditions are not met, then the method ends at step 840. In step 850 the value of k is incremented. In step 860 an intersection of the computed area A and a perpendicular bisector ⊥pᵢpₖ is calculated. It is then determined in step 870 that l is not equal to 0 i.e. that the perpendicular bisector ⊥pᵢpₖ does pass through the area A. In the case that it does, a value of d is calculated in step 880. The value d is a distance between the perpendicular bisector ⊥pᵢpₖ and the circular arc. If l=0 in step 870, or once d has been calculated in step 880, a new value of A is calculated in step 890 by an intersection of the existing value of A and a new hyperbola between pᵢ and an error disc Dᵢ₊₁.

It can be seen from FIG. 8 that the method is performed recursively, by the gradual introduction of further points. Following the introduction of a further point, it is determined if it is still possible to fit a circular arc between start and end points through the error discs of all intermediate points. If it is not, then l=0 and a circular arc can be used to represent the plurality of points considered at the last iteration.

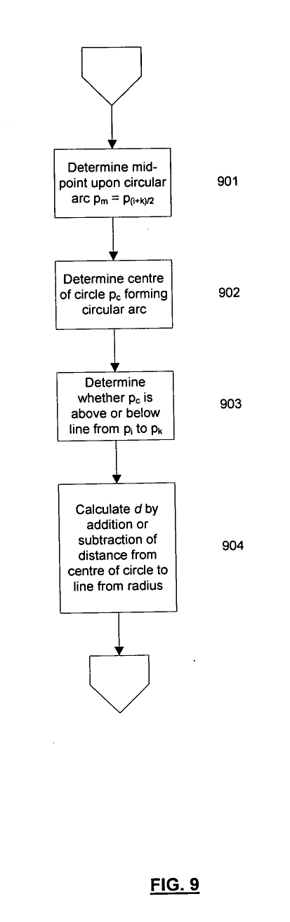

A method of calculating d in step 880 will now be explained with reference to FIG. 9.

In order to determine the value d three points upon the circular arc are used: the first point pᵢ, the last point pₖ, and a third point which, in the preferred embodiment, is the mid point pₘ=p_{(i+k)/2}. This mid point is determined in step 901 of the method shown in FIG. 9, which is performed in step 880 of FIG. 8.

In step 902, a centre of a circle p_{c} of which the circular arc is a subsection of is calculated. A distance between pᵢ or pₖ and p_{c} is the radius of the circle, whilst, it will be remembered d is the distance between the line bisecting pᵢ and pₖ p̅ᵢ̅p̅ₖ̅ and the circular arc. Therefore, it is necessary to calculate on which side of the line p̅ᵢ̅p̅ₖ̅ lies the centre p_{c}. This is performed in step 903.

If it is determined in step 903 that p_{c} is below the line ⊥pᵢpₖ then:

d=distance(pi,pc)−distance( p̅ᵢ̅p̅ₖ̅,pc)

In other words, d equals the radius of the circle minus the distance from the centre of the circle to the line intersecting pᵢ and pₖ. However, if p_{c} is above the line, then:

d=distance(pi,pc)+distance( p̅ᵢ̅p̅ₖ̅,pc)

That is, d equals the radius of the circle plus the distance from the centre of the circle to the line intersecting pᵢ and pₖ.
If a function SideOfLine( p̅ᵢ̅p̅ₖ̅,pₓ) is used, which returns 1 or −1 depending upon which side of the line p̅ᵢ̅p̅ₖ̅ pₓ is determined to be, the above calculation can be written as:

d=[distance( p̅ᵢ̅p̅ₖ̅,pm)×SideOfLine( p̅ᵢ̅p̅ₖ̅,pm)]+[distance( p̅ᵢ̅p̅ₖ̅,pc)×SideOfLine( p̅ᵢ̅p̅ₖ̅,p_{c})]

In the above equation, SideOfLine is used to cause addition or subtraction of the relevant distances depending upon whether p_{c} is above or below the line p̅ᵢ̅p̅ₖ̅. Thus, the value of d is calculated in step 904.

In the above-described method, it is necessary to determine hyperbolas between points and error discs of points. Whilst computation of a hyperbola using intersections of conic polygons is possible, a preferred embodiment of the present invention uses a polygonal approximation h′ of the hyperbola h.

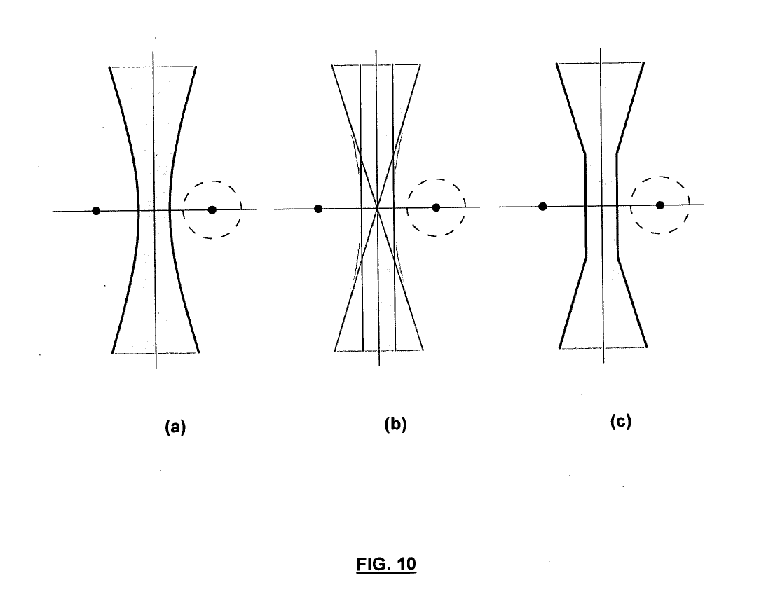

FIG. 10(a) shows a pair of hyperbola, FIG. 10(b) shows asymptotes and tangents for the pair of hyperbola shown in (a) and FIG. 10 (c) shows an approximation h′ to the pair of hyperbola.

To approximate the pair of hyperbola shown in FIG. 10(a) to important properties of hyperbola will be utilised: every hyperbola has two asymptotes, both through (0, 0) and two tangents which are parallel to the y-axis and x-intercept. The coordinates are relative to the hyperbola; (0,0) is a point between focal points F₁ and F₂. The asymptotes and tangents may be calculated as:

### Asymptotes:

$$y = \pm \frac{b}{a} x$$

### Tangents:

x=F₁F₂±α

The asymptotes and tangents are shown in FIG. 10(b) and allow an approximation shown in FIG. 10(c) to be calculated.

Such an approximation has a slightly smaller area than a true hyperbola, so some shortcuts may in theory be rejected, but false positives will never be generated. An error of the approximation may be reduced by use of more than two tangents. As shown in FIG. 9(c) a polygonal approximation has an infinite size. A variable A may be introduced to limit a length of the approximation. The length is measured along one asymptote, starting at a point where asymptotes cross.

It is further necessary to calculate polygonal intersection and for this purpose any polygonal intersection algorithm may be used, such as a sweep line algorithm.

In order to ensure that an arc is a good approximation to a plurality of points, embodiments of the present invention use one or both of a distance threshold and an angle threshold.

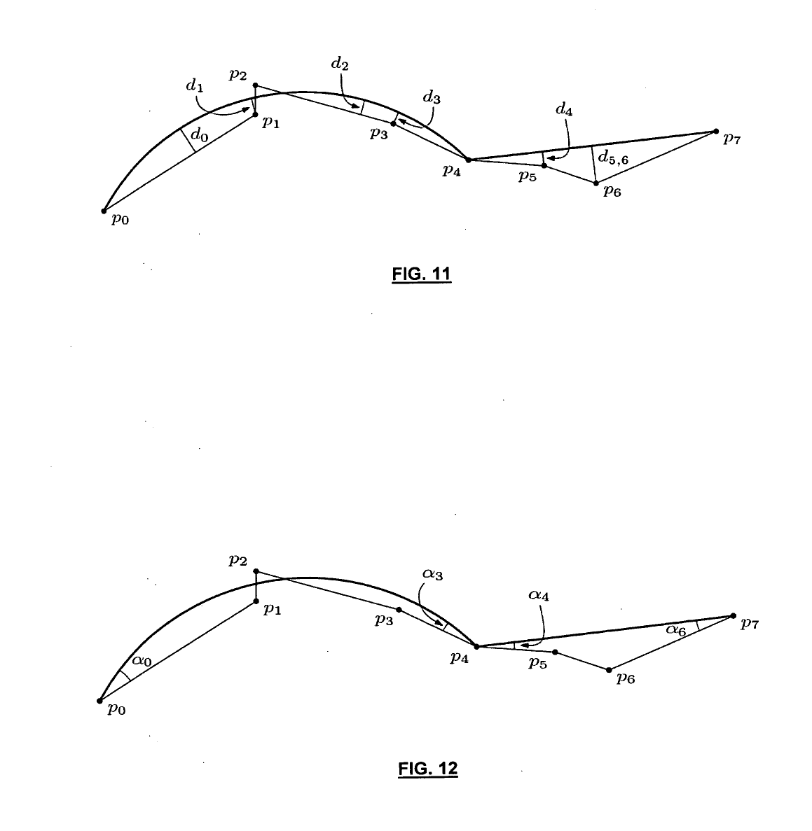

A distance threshold is a maximum distance that an arc may deviate from a line segment between consecutive points. That is, a maximum deviation value E is introduced which is a maximum allowable distance between a straight line segment p̅q̅ and a circular arc [symbol] between those points. The distance is a distance between p̅q̅ and [symbol] at point where [symbol] has the same slope as p̅q̅. In cases where the arc and line segments don't share both start and end points, the distance dₖ is a maximum distance between a line segment p̅ₖ̅p̅ₖ̅₊̅₁̅ and an arc bypassing that segment, as shown in FIG. 11 for a polyline consisting of points p0, p1 . . . p8 approximated with a circular arc [symbol] and a line segment p̅₄̅p̅₈̅.

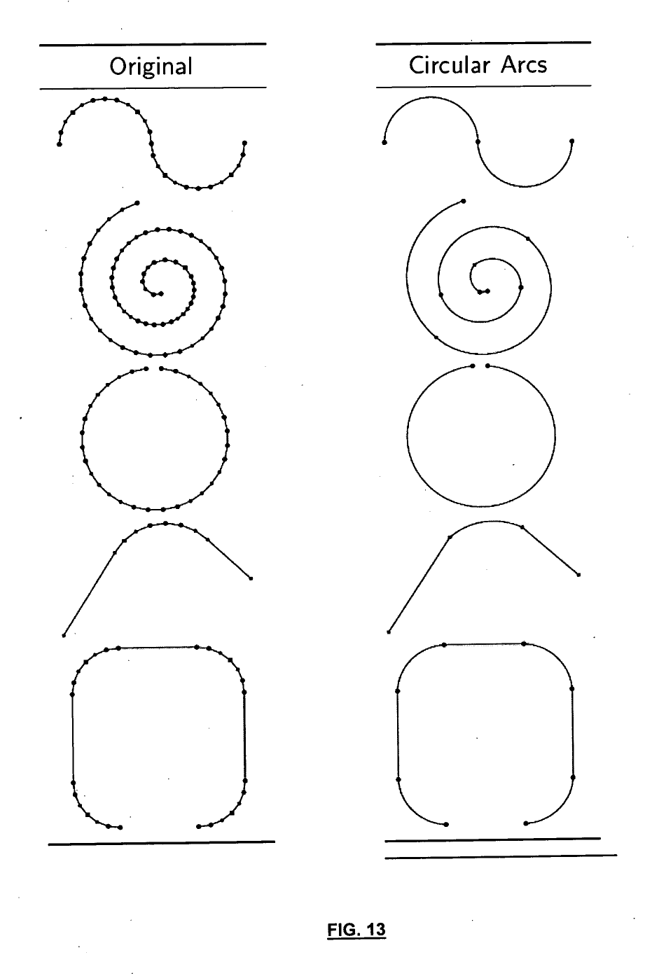

An angle threshold may also be used to prevent an angle of an incoming arc and a line segment differing by too great an extent. An angle αₖ is considered between p̅ₖ̅p̅ₖ̅₊̅₁̅ and an arc bypassing that segment. FIG. 12 shows the same set of points as in FIG. 11 and approximations with the angle threshold considered. It is determined that the angle αₖ is below a maximum approximation angle.

FIG. 13 shows various test data with circular arc approximations calculated, demonstrating that in many cases an original set of polydata may be represented with significantly fewer point when using circular arc approximations between points.

It will be apparent from the foregoing that the teachings of the present invention provide a method of reducing a number of points forming map data. A result of embodiments of the present invention is that map data for a region may be held on a reduced memory capacity, thus decreasing a cost of a navigation device.

It will also be appreciated that whilst various aspects and embodiments of the present invention have heretofore been described, the scope of the present invention is not limited to the particular arrangements set out herein and instead extends to encompass all arrangements, and modifications and alterations thereto, which fall within the scope of the appended claims.

For example, whilst embodiments described in the foregoing detailed description refer to GPS, it should be noted that the navigation device may utilise any kind of position sensing technology as an alternative to (or indeed in addition to) GPS. For example the navigation device may utilise using other global navigation satellite systems such as the European Galileo system. Equally, it is not limited to satellite based but could readily function using ground based beacons or any other kind of system that enables the device to determine its geographic location.

It will also be well understood by persons of ordinary skill in the art that whilst the preferred embodiment implements certain functionality by means of software, that functionality could equally be implemented solely in hardware (for example by means of one or more ASICs (application specific integrated circuit)) or indeed by a mix of hardware and software. As such, the scope of the present invention should not be interpreted as being limited only to being implemented in software.

Lastly, it should also be noted that whilst the accompanying claims set out particular combinations of features described herein, the scope of the present invention is not limited to the particular combinations hereafter claimed, but instead extends to encompass any combination of features or embodiments herein disclosed irrespective of whether or not that particular combination has been specifically enumerated in the accompanying claims at this time.

1. A method of using a suitably programmed computer to fit a circular arc to a plurality of points, comprising:
determining whether a region, in which a centre of a circle intersecting a first point and a region around at least one mid-point lies, intersects a perpendicular bisector of a line intersecting the first point and a second point.

2. The method of claim 1, comprising representing the plurality of points as the coordinates of the first and second points, and a distance d between the line intersecting the first and second points and the circular arc.

3. The method of claim 1, wherein the determining step is performed recursively and, for each recursion, the second point becomes a further mid-point and a new second point is introduced.

4. The method of claim 2, wherein the value d is determined by calculating a radius of the circle and a distance between the centre of the circle and the line intersecting the first and second points.

5. The method of claim 1, wherein the region is determined by determining an area formed by an intersection of a plurality of hyperbolas.

6. The method of claim 5, wherein each hyperbola is formed by a pair of loci representing lines along which lie centres of circles intersecting the first point and a circular region around a further point tangential to an inside and an outside of the circular region around the further point, respectively.

7. The method of claim 5, comprising determining an approximation for each of the plurality of hyperbolas.

8. The method of claim 7, wherein the approximation comprises an intersection between a pair of asymptotes and a tangent.

9. The method of claim 7, comprising limiting the approximation to a predetermined length along one of the asymptotes.

10. The method of claim 1, comprising determining whether a maximum deviation between the circular arc and a polyline formed between the plurality of points is less than a predetermined distance.

11. The method of claim 1, comprising determining whether a maximum angle between the arc a polyline formed between the plurality of points at the first and end points respectively is less than a predetermined angle.

12. The method of claim 1, wherein the plurality of points form map data representing a feature.

13. A non-transitory data storage medium comprising computer executable instructions which, when executed by a processor, cause the processor to perform the method of claim 1.

14. An apparatus comprising:
a processor; and
a memory operatively coupled to the processor,
the memory comprising coordinates of a plurality of points; and
the processor being arranged to determine whether a region, in which a centre of a circle intersecting a first point and a region around at least one mid-point lies, intersects a perpendicular bisector of a line intersecting the first point and a second point.

15. The apparatus of claim 14, wherein the processor is arranged to store in the memory a representation of the plurality of points formed by the coordinates of the first and second points, and a distance d between the line intersecting the first and second points and the circular arc.
